(19) United States
(12) Patent Application Publication
(10) Pub. No.: US 2012/0103312 A1
(43) Pub. Date: May 3, 2012

(54) CONTROL DEVICE FOR INTERNAL COMBUSTION ENGINE

(75) Inventors: Mie Sasai, Susono-shi (JP); Kazuhiro Wakao, Susono-shi (JP)

(73) Assignee: TOYOTA JIDOSHA KABUSHIKI KAISHA, Toyota-shi, Aichi-ken (JP)

(21) Appl. No.: 13/259,376

(22) PCT Filed: Apr. 5, 2010
(86) PCT No.: PCT/JP2010/056188

§ 371 Date: Sep. 23, 2011

(51) Int. Cl. F02D 19/06; F02D 17/00

(52) U.S. Cl. 123/575

(57) ABSTRACT

An object of the present invention is to avoid an air-fuel ratio difference between cylinders upon recovery from a cylinder deactivation in a situation where some of a plurality of cylinders of an internal combustion engine capable of using a plurality of types of fuels having different properties are to be deactivated upon the halt of fuel injection from an injector.

To accomplish the object, a control device to which the present invention is applied includes a fuel property sensor that is installed in a fuel line between a fuel tank and a delivery pipe, and detects a fuel property change from a change in a signal of the fuel property sensor. Upon detection of a fuel property change, the control device prohibits the deactivation of a cylinder before the completion of a fuel property change in the delivery pipe.

### TECHNICAL FIELD

The present invention relates to a control device for an internal combustion engine that is capable of using a plurality of types of fuels having different properties. More specifically, the present invention relates to an internal combustion engine control device having a cylinder deactivation function that deactivates some of a plurality of cylinders.

### BACKGROUND ART

An internal combustion engine capable of using fuels having different properties is mounted in a so-called FFV (flexible-fuel vehicle). An example of such an FFV internal combustion engine described, for instance, in JP-A-2006-322401 is capable of using gasoline and alcohol. When fuels having different properties are to be used, an air-fuel ratio needs to be adjusted in accordance with fuel properties. When, for instance, alcohol-blended gasoline is used as fuel, it is necessary to adjust the air-fuel ratio in accordance with the concentration of alcohol in the fuel because the alcohol greatly differs from gasoline in calorific value per unit volume.

The use of a fuel property sensor makes it possible to determine the property of an employed fuel. A fuel tank for the FFV internal combustion engine disclosed in JP-A-2006-322401 is provided with an alcohol concentration sensor. When the alcohol concentration sensor is used to determine the alcohol concentration of a fuel, air-fuel ratio control can be exercised in accordance with the alcohol concentration.

A technology disclosed in JP-A-2009-203900 stops fuel injection from injectors to deactivate some of a plurality of cylinders. This cylinder deactivation technology can be applied to the above-mentioned FFV internal combustion engine. In such an instance, however, there arises the following problem.

FIG. 1 in JP-A-2006-322401 shows the configuration of a fuel supply system for an FFV internal combustion engine, which is also applicable to a common internal combustion engine. As indicated in the figure, the same fuel line (fuel supply path) is used to supply fuel from a fuel tank to injectors for individual cylinders. A delivery pipe is disposed downstream of the fuel line. The injectors for the individual cylinders are disposed in the axial direction of the delivery pipe for connection purposes. The fuel is supplied from the fuel tank to the delivery pipe through the fuel line. Next, the fuel is sequentially distributed to the injectors for the individual cylinders beginning with the injector closest to the inlet of the delivery pipe.

FIG. 6 is a time diagram that indicates how the alcohol concentration of an injector-injected fuel for each cylinder changes when the concentration of alcohol in a fuel tank changes due to fueling. The figure shows a case where alcohol-blended gasoline is added to a fuel tank that contains gasoline only. A change in the alcohol concentration of an injector-injected fuel occurs with a delay after a change in the alcohol concentration at the outlet of a fuel pump. The reason is that a fuel (the fuel for the last trip) remains in the fuel line and delivery pipe before the start of fueling. After the remaining fuel is consumed upon injection into each cylinder, the change in the alcohol concentration is reflected in the injector-injected fuel.

Response time, which is required for the change in the alcohol concentration to be reflected in the injector-injected fuel, varies from one cylinder to another. The response time varies from one cylinder to another due to the difference in a flow path length, that is, the distance between the inlet of the delivery pipe and the injector for each cylinder. The change in the alcohol concentration is reflected in the injector-injected fuel in order from the shortest distance between the inlet of the delivery pipe and the injector for each cylinder to the longest. Therefore, the cylinder located farthest from the inlet of the delivery pipe, that is, the cylinder located most downstream in the direction of fuel flow in the delivery pipe (hereinafter referred to as the most downstream cylinder), experiences the change in the alcohol concentration of the injector-injected fuel later than the other cylinders.

The fuel flow in the delivery pipe is caused by the injection of fuel from the injectors for the individual cylinders. However, when the most downstream cylinder is deactivated by the above-described cylinder deactivation technology, a region where the fuel does not readily flow is formed near the most downstream portion of the delivery pipe. Therefore, if the most downstream cylinder is deactivated during a transition period during which the alcohol concentration in the delivery pipe changes, the fuel existing before the change in the alcohol concentration (the fuel existing before the start of fueling) remains near the most downstream portion of the delivery pipe.

If recovery from a cylinder deactivation is achieved in the above-described situation, the fuel remaining in the delivery pipe is injected into the most downstream cylinder although the alcohol concentration of the fuel injected into the other cylinders is already changed to the one prevailing after fueling. Thus, there arises a significant air-fuel ratio difference between the most downstream cylinder and the other cylinders. This degrades driving performance and emissions performance. One task to be accomplished when applying the cylinder deactivation technology to the FFV internal combustion engine is to avoid an air-fuel ratio difference between cylinders when recovery from a cylinder deactivation is achieved.

### SUMMARY OF THE INVENTION

The present invention has been made in view of the above circumstances. An object of the present invention is to avoid an air-fuel ratio difference between cylinders when recovery from a cylinder deactivation is achieved in an internal combustion engine capable of using a plurality of types of fuels having different properties.

To achieve the above-described object, the present invention provides a below-described control device for an internal combustion engine.

According to one aspect of the present invention, the control device includes a fuel property sensor that is installed in a fuel line between a fuel tank and a delivery pipe. The fuel property sensor detects a change in a fuel property from a change in a signal generated by the fuel property sensor. The control device is capable of deactivating some of a plurality of cylinders by halting the injection of fuel from an injector. In such a cylinder deactivation, a valve stop mechanism may stop either an exhaust valve or an intake valve in a closed state. The cylinders to be deactivated may be determined in advance or determined in an arbitrary manner. When a change in the fuel property is detected, the control device prohibits the deactivation of a cylinder before the completion of the change in the fuel property in the delivery pipe. Whether the change in the fuel property in the delivery pipe is completed can be estimated in accordance, for instance, with a fuel injection amount for each cylinder. The control device having the above-described function is capable of preventing a fuel having a property prevailing before the change from remaining in the delivery pipe.

The control device may prohibit the deactivation of a cylinder in the following preferred modes. In one preferred mode, the control device prohibits the deactivation of a cylinder located farthest from the inlet of the delivery pipe before the completion of a change in the fuel property in the delivery pipe. In another preferred mode, the control device prohibits the deactivation of a cylinder affected last by a change in the fuel property before the completion of the change in the fuel property in the delivery pipe. In the above-mentioned modes, the control device permits the other cylinders to deactivate even before the completion of the change in the fuel property in the delivery pipe. In still another preferred mode, the control device prohibits all cylinders to be deactivated from being deactivated before the completion of the change in the fuel property in the delivery pipe.

According to another aspect of the present invention, the control device prohibits the execution of an abnormality diagnosis related to an air-fuel ratio until a predetermined period of time elapses after recovery from a cylinder deactivation. Therefore, even if the air-fuel ratio varies from one cylinder to another when recovery from a cylinder deactivation is achieved, the control device prevents a wrong abnormality diagnosis from being made due to such an air-fuel ratio variation.

According to another aspect of the present invention, the control device prohibits the learning of a control parameter related to an air-fuel ratio until a predetermined period of time elapses after recovery from a cylinder deactivation. Therefore, even if the air-fuel ratio varies from one cylinder to another when recovery from a cylinder deactivation is achieved, the control device prevents a control parameter from being erroneously learned due to such an air-fuel ratio variation.

According to still another aspect of the present invention, the control device estimates a fuel property in the delivery pipe. When recovery from a cylinder deactivation is achieved, the control device estimates the fuel property in the injector for a recovered cylinder from the amount of fuel consumption in the cylinder and the fuel property in the delivery pipe. The control device provides fuel injection amount control of the recovered cylinder in accordance with the estimated fuel property in the injector until a predetermined period of time elapses after the recovery from the cylinder deactivation. Consequently, even if a fuel having a property prevailing before a fuel property change remains in the delivery pipe or injector, it is possible to reduce the air-fuel ratio difference between the cylinders, which arises upon recovery from a cylinder deactivation.

The following preferred methods may be used to estimate the fuel property in the delivery pipe. One method is to use the aforementioned fuel property sensor. The fuel property in the delivery pipe can be estimated in accordance with the fuel property in the fuel line, which is identified by a signal generated from the fuel property sensor. Another method is to use an air-fuel ratio sensor installed in an exhaust path of the internal combustion engine. The fuel property in the delivery pipe can be estimated in accordance with an exhaust air-fuel ratio, which is identified by a signal generated from the air-fuel ratio sensor.

### BRIEF DESCRIPTION OF DRAWINGS

FIG. 1 is a schematic diagram illustrating the configuration of an internal combustion engine fuel supply system to which a control device according to a first embodiment of the present invention is applied.

FIG. 2 is a flowchart illustrating a cylinder-to-be-deactivated selection routine that is executed in the first embodiment of the present invention.

FIG. 3 is a flowchart illustrating an OBD execution condition judgment routine that is executed in the first embodiment of the present invention.

FIG. 4 is a flowchart illustrating a cylinder-specific injected fuel concentration calculation routine that is executed in the first embodiment of the present invention.

FIG. 5 is a flowchart illustrating the cylinder-specific injected fuel concentration calculation routine that is executed in a second embodiment of the present invention.

FIG. 6 is a time diagram that indicates how a fuel property changes in various sections of a fuel supply path after fueling.

### BEST MODE FOR CARRYING OUT THE INVENTION

### First Embodiment

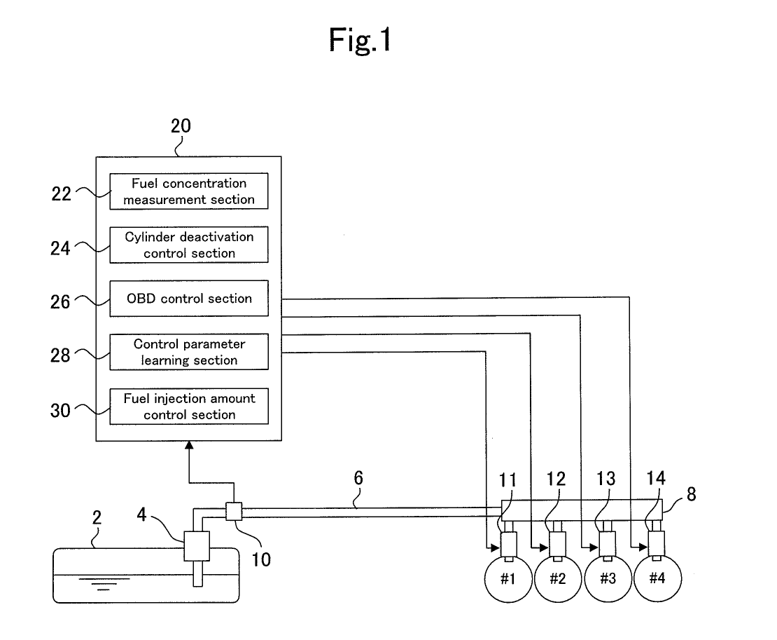

A first embodiment of the present invention will now be described with reference to FIGS. 1 to 4.

A control device according to the first embodiment is applied to an FFV internal combustion engine that can use not only gasoline but also biofuel-blended gasoline. FIG. 1 is a schematic diagram illustrating the configuration of a fuel supply system for such an internal combustion engine.

The fuel supply system shown in FIG. 1 is configured so that a fuel line 6 is connected between a fuel tank 2 and a delivery pipe 8. The fuel line 6 is connected to one end of the delivery pipe 8. From an inlet to a rear end, four injectors 11, 12, 13, and 14 are sequentially arranged and connected to the delivery pipe 8. The internal combustion engine used in the present embodiment is an in-line four-cylinder engine. The numerals #1, #2, #3, and #4 in FIG. 1 are cylinder numbers. A fuel pump 4 is attached to a fuel tank 2 side end of the fuel line 6. The fuel pump 4 draws fuel from the fuel tank 2 and pumps the fuel to the fuel line 6. The fuel, which is supplied from the fuel tank 2 to the delivery pipe 8 through the fuel line 6, is sequentially distributed to the injectors 11, 12, 13, 14 for the individual cylinders beginning with the injector closest to the inlet of the delivery pipe 8.

A fuel property sensor 10 is installed in the middle of the fuel line 6. The fuel property sensor 10 used in the present embodiment is a biofuel concentration sensor that outputs a signal in accordance with the concentration of a biofuel in the fuel. Hence, in the present embodiment, the term “fuel property” represents the concentration of the biofuel (hereinafter simply referred to as the fuel concentration). A signal of the biofuel concentration sensor 10 enters an ECU 20 of the internal combustion engine.

The control device according to the present embodiment is formed by the ECU 20 and the biofuel concentration sensor 10. The ECU 20 can be functionally divided into a fuel concentration measurement section 22, a cylinder deactivation control section 24, an OBD control section 26, a control parameter learning section 28, and a fuel injection amount control section 30. These functional elements 22, 24, 26, 28, 30 are selected from various functional elements included in the ECU 20 and depicted in the figure as they are relevant to the present invention. In other words, FIG. 1 does not indicate that the ECU 20 includes the functional elements 22, 24, 26, 28, 30 only. The functional elements 22, 24, 26, 28, 30 may be implemented by their respective hardware or may be virtually implemented by software while sharing the same hardware.

The functional elements 22, 24, 26, 28, 30 included in the ECU 20 will now be described in detail.

### <Fuel Concentration Measurement Section>

The fuel concentration measurement section 22 is capable of receiving a signal from the biofuel concentration sensor 10 and identifying fuel concentration at a position at which the biofuel concentration sensor 10 is mounted. The fuel concentration measurement section 22 is also capable of estimating the fuel concentration in the delivery pipe 8 in accordance with a signal of the biofuel concentration sensor 10. When the fuel concentration in the delivery pipe is to be estimated, first of all, a fuel flow path between the delivery pipe 8 and the mounting position of the biofuel concentration sensor 10 is divided virtually and one-dimensionally into small regions having an equal volume. Next, a cell, which stores a fuel concentration, is assigned to each small region. When the fuel having a volume equivalent to one small region is consumed, the fuel concentration of each cell is shifted one position downstream. In addition, a cell assigned to a region corresponding to the position of the biofuel concentration sensor 10 stores a fuel concentration that is identified from the signal of the biofuel concentration sensor 10. The fuel concentration measurement section 22 tracks the movement of the fuel concentration in the fuel flow path by shifting the data of a cell corresponding to each small region as described above, and estimates the fuel concentration in the delivery pipe 8.

### <Cylinder Deactivation Control Section>

The cylinder deactivation control section 24 is capable of deactivating some of a total of four cylinders included in the internal combustion engine. In a cylinder deactivation, the injector stops its fuel injection and a valve stop mechanism stops either an intake valve or an exhaust valve in a closed state. A cylinder to be deactivated is determined in accordance with a crank angle prevailing at a timing at which the execution conditions for a cylinder deactivation are met. More specifically, a cylinder that can complete a cylinder deactivation at the earliest timing is selected as the cylinder to be deactivated. However, the aforementioned problem may occur depending on the selected cylinder.

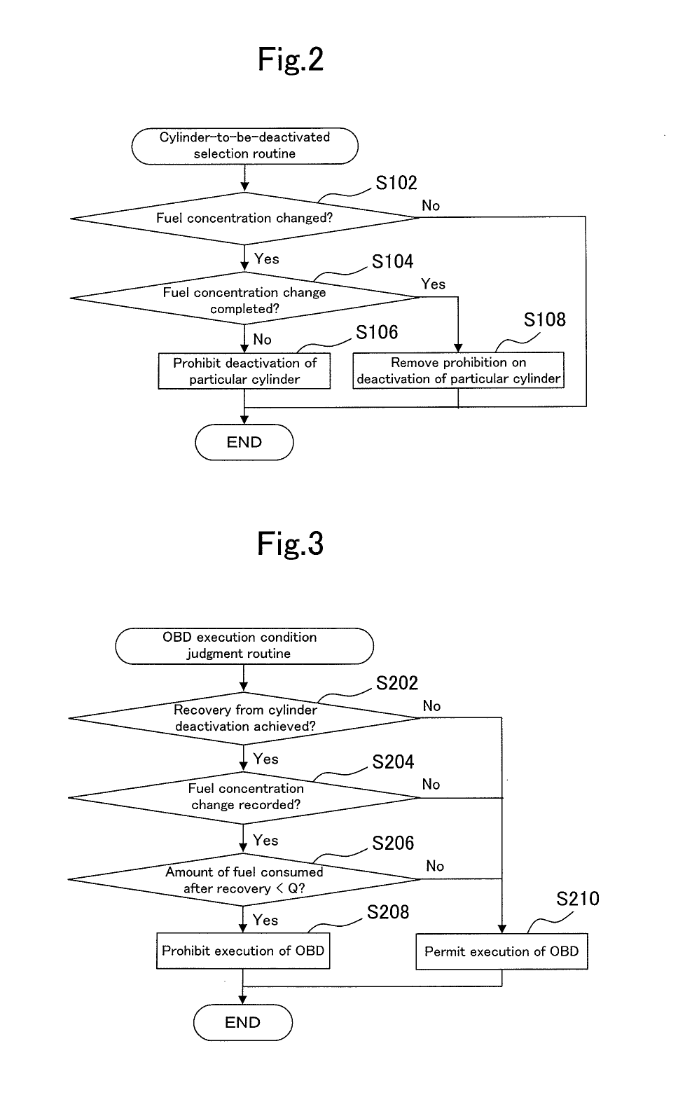

To avoid an improper cylinder selection, the cylinder deactivation control section 24 constantly executes a cylinder-to-be-deactivated selection routine at regular intervals as indicated by a flowchart of FIG. 2.

In step S102, which is the first step, the cylinder-to-be-deactivated selection routine judges whether the fuel concentration in the fuel line 6 is changed. A change in the fuel concentration can be detected in accordance with a change in the signal of the biofuel concentration sensor 10. The fuel concentration in the fuel line 6 may change when, for instance, a fuel differing in concentration from a fuel remaining in the fuel tank 2 is newly added. When the fuel concentration in the fuel tank 2 is changed by fueling, the fuel concentration in the fuel line 6 changes, and then the fuel concentration in the delivery pipe 8 changes with a delay. When the fuel concentration remains unchanged, the routine terminates.

When a change in the fuel concentration is detected, the routine proceeds to step S104. In step S104, the routine judges whether the change in the fuel concentration in the delivery pipe 8 is completed. A fuel path formed by the fuel line 6 and the delivery pipe 8 has a fixed volumetric capacity. Therefore, there is a time lag between the instant at which a fuel having a changed concentration arrives at the inlet of the delivery pipe 8 and the instant at which the fuel concentration in the delivery pipe 8 is uniformly changed. In step S104, the routine calculates the difference between the fuel concentration in the delivery pipe 8, which is estimated by the fuel concentration measurement section 22, and the fuel concentration identified from the signal of the biofuel concentration sensor 10. When the calculated difference is not greater than a predetermined value, the routine concludes that the change in the fuel concentration in the delivery pipe 8 is completed.

If the judgment result obtained in step S104 indicates that the change in the fuel concentration is still not completed, the routine proceeds to step S106. In step S106, the routine prohibits the deactivation of a particular cylinder. The particular cylinder is a cylinder that is located farthest from the inlet of the delivery pipe 8. When the employed configuration is as shown in FIG. 1, the fourth cylinder is designated as the particular cylinder. When the execution conditions for a cylinder deactivation are met while the deactivation of the particular cylinder is prohibited, the particular cylinder is not selected as the cylinder to be deactivated no matter whether a cylinder that can complete a cylinder deactivation at the earliest timing is the cylinder to be deactivated. In this instance, the cylinder to be deactivated is selected from cylinders other than the particular cylinder.

When the judgment result obtained in step S104 indicates that the change in the fuel concentration in the delivery pipe 8 is completed, the routine proceeds to step S108. In step S108, the routine removes the prohibition on the deactivation of the particular cylinder. Thus, the particular cylinder may be selected as the cylinder to be deactivated depending on the timing at which the execution conditions for a cylinder deactivation are met. In other words, after the change in the fuel concentration in the delivery pipe 8 is completed, a cylinder that can complete a cylinder deactivation at the earliest timing is selected as the cylinder to be deactivated no matter whether it is the particular cylinder.

When the above-described routine is executed during a transition period during which the fuel concentration in the delivery pipe 8 is changing, the fourth cylinder, which is located farthest from the inlet of the delivery pipe 8, is not selected as the cylinder to be deactivated. This ensures that the fuel existing before the change in the fuel concentration (the fuel existing before the start of fueling) does not remain near the most downstream portion of the delivery pipe 8. As a result, an air-fuel ratio difference between cylinders is avoided when recovery from a cylinder deactivation is achieved.

### <OBD Control Section>

The OBD control section 26 is capable of making an OBD (on-board diagnosis) of the internal combustion engine, or more particularly, making an OBD by using a signal of an air-fuel ratio sensor. The OBD includes an abnormality diagnosis of the air-fuel ratio sensor and an abnormality diagnosis of a fuel system. The OBD control section 26 makes an OBD at a timing at which predetermined execution conditions are met. However, if the execution timing of an OBD coincides with the timing of recovery from a cylinder deactivation, the accuracy of the OBD may be degraded. When an OBD is to be made with the signal of the air-fuel ratio sensor, it is a prerequisite that an air-fuel ratio be accurately controlled. When recovery from a cylinder deactivation is achieved, it is probable that the accuracy of air-fuel ratio control may be degraded due to a change in the fuel concentration that can be caused, for instance, by fueling.

In the present embodiment, the above-described cylinder-to-be-deactivated selection routine is executed to ensure that the air-fuel ratio does not vary from one cylinder to another when recovery from a cylinder deactivation is achieved. However, if the fuel concentration changes before a cylinder deactivation, there is a slight possibility that the fuel existing before fueling (the fuel existing before a change in the fuel concentration) may remain in the injector for the cylinder to be deactivated. In such an instance, the air-fuel ratio difference between cylinders persists until the injector completely injects the remaining fuel upon recovery from a cylinder deactivation.

As such being the case, the OBD control section 26 executes an OBD execution condition judgment routine as indicated by a flowchart of FIG. 3 at the time of OBD execution.

In step S202, which is the first step, the OBD execution condition judgment routine judges whether recovery from a cylinder deactivation is achieved. If a cylinder deactivation is still not initiated or is in progress, the routine concludes that recovery from a cylinder deactivation is not achieved. In such an instance, the routine proceeds to step S210 and permits the execution of an OBD.

If, on the other hand, recovery from a cylinder deactivation is already achieved, the routine proceeds to step S204. In step S204, the routine judges whether there is a record of a fuel concentration change that occurred before a cylinder deactivation. When the fuel concentration has not changed before the cylinder deactivation, the air-fuel ratio will not possibly vary from one cylinder to another when recovery from a cylinder deactivation is achieved. Therefore, when there is no record of a fuel concentration change, the routine proceeds to step S210 and permits the execution of an OBD.

When, on the other hand, there is a record of a fuel concentration change, the routine proceeds to step S206, which is the next judgment step. In step S206, the routine judges whether the amount of fuel consumed by each cylinder upon fuel injection from the injector after recovery from a cylinder deactivation is smaller than a reference amount Q. The reference amount Q is the amount of fuel consumption that is required for the injector to completely inject the fuel remaining in the injector (the fuel existing before a change in the fuel concentration). For example, the reference amount Q may be equivalent to the volumetric capacity of fuel in the injector. When the amount of fuel consumption after recovery is smaller than the reference amount Q, it is possible that the fuel existing before a concentration change may remain in the injector. Therefore, in such an instance, the routine proceeds to step S208 and prohibits the execution of an OBD.

When, on the other hand, the amount of fuel consumption after recovery is not smaller than the reference amount Q, the air-fuel ratio will not possibly vary from one cylinder to another. Therefore, in such an instance, the routine proceeds to step S210 and permits the execution of an OBD.

When the above-described routine is executed in a situation where the accuracy of air-fuel ratio control is degraded upon recovery from a cylinder deactivation, the execution of an OBD based on an air-fuel ratio sensor signal is avoided. Consequently, the possibility of an erroneous diagnosis due to a cylinder deactivation can be eliminated.

### <Control Parameter Learning Section>

The control parameter learning section 28 is capable of learning the values of control parameters related to the air-fuel ratio. The control parameters include various correction amounts for air-fuel ratio feedback control. A signal of the air-fuel ratio sensor is used to learn the control parameters. Therefore, as is the case with the aforementioned OBD, the accuracy of control parameter learning may be degraded if the timing of control parameter learning coincides with the timing of recovery from a cylinder deactivation.

To avoid the above problem, the control parameter learning section 28 executes a learning condition judgment routine as described below at the time of control parameter learning.

The learning condition judgment routine is similar to the above-described OBD execution condition judgment routine. The learning condition judgment routine can be created by replacing the process in step S208 of the OBD execution condition judgment routine with a “learning prohibition” process and by replacing the process in step S208 with a “learning permission” process. Therefore, when recovery from a cylinder deactivation has been achieved and there is a record of a fuel concentration change before the cylinder deactivation, the learning condition judgment routine prohibits the learning of control parameters until the amount of fuel consumption after recovery is not smaller than the reference amount Q.

When the above-described routine is executed in a situation where the accuracy of air-fuel ratio control is degraded upon recovery from a cylinder deactivation, the learning of control parameters with an air-fuel ratio sensor signal is avoided. Consequently, the possibility of erroneous learning due to a cylinder deactivation can be eliminated.

### <Fuel Injection Amount Control Section>

The fuel injection amount control section 30 is capable of controlling a fuel injection amount on an individual cylinder basis. As a target air-fuel ratio, which is the basis of fuel injection amount calculations, the same value is generally applied to all cylinders. However, if a cylinder deactivation is performed as mentioned earlier during a transition period during which the fuel concentration is changing, the fuel existing before the concentration change may remain in the injectors for some cylinders. In such an instance, the fuel concentration of an injected fuel varies from one cylinder to another for a certain period of time after recovery from the cylinder deactivation. If fuel injection amount control is exercised by using a single target air-fuel ratio in a situation where there is a difference in fuel concentration, the air-fuel ratio difference between the cylinders is great.

As such being the case, the fuel injection amount control section 30 estimates the fuel concentration of injected fuel on an individual cylinder basis. Further, the fuel injection amount control section 30 sets a cylinder-specific target air-fuel ratio in accordance with the estimated fuel concentration of injected fuel, and exercises fuel injection amount control in accordance with the cylinder-specific target air-fuel ratio. A routine shown in a flowchart of FIG. 4 is used by the fuel injection amount control section 30 to calculate a cylinder-specific injected fuel concentration. This cylinder-specific injected fuel concentration calculation routine is described below.

Each time the cylinder-specific injected fuel concentration calculation routine shown in FIG. 4 is executed, it calculates an injected fuel concentration in each cylinder. The routine execution count is indicated by “i”, and the injected fuel concentration in the n-th cylinder that is calculated for an i-th time is indicated by En(i).

In step S302, which is the first step, the routine estimates the fuel concentration in the delivery pipe 8 (hereinafter referred to as the delivery concentration) Ed(i) by the earlier-described estimation method. The delivery concentration Ed(i) is updated each time.

In the next step, which is step S304, the routine judges whether a cylinder deactivation is performed. When a cylinder deactivation is being performed, the routine performs steps S312 and S314 in sequence. In step S312, the routine performs calculations on a deactivated cylinder to determine the last injected fuel concentration En(i-1) as the current injected fuel concentration En(i). In step S314, the routine performs calculations on a non-deactivated cylinder to determine the current delivery concentration Ed(i) as the current injected fuel concentration En(i).

When, on the other hand, no cylinder deactivation is currently performed, the routine proceeds to step S306. In step S306, the routine judges whether there is a record of a cylinder deactivation. When no cylinder deactivation was performed in the past, the fuel concentration of injected fuel does not vary from one cylinder to another. Therefore, when there is no record of a cylinder deactivation, the routine performs step S314. More specifically, the routine handles all cylinders as a non-deactivated cylinder and calculates the current delivery concentration Ed(i) as the current injected fuel concentration En(i).

When there is a record of a cylinder deactivation, the routine additionally performs step S308 for judgment purposes. In step S308, the routine checks a cylinder having a record of a cylinder deactivation to determine whether the amount of fuel consumed after recovery from the cylinder deactivation is smaller than the volumetric capacity of fuel in the injector Vinj. When the amount of fuel consumed after recovery is already larger than the volumetric capacity of fuel in the injector Vinj, the fuel existing before a concentration change does not possibly remain in the injector. In this instance, therefore, the routine proceeds to step S314 and performs calculations on all cylinders to determine the current delivery concentration Ed(i) as the current injected fuel concentration En(i).

When the amount of fuel consumed after recovery is smaller than the volumetric capacity of fuel in the injector Vinj, it is possible that the fuel existing before the concentration change may remain in the injector. In this instance, it is probable that there may be a difference in injected fuel concentration between a cylinder having a record of a cylinder deactivation and a cylinder having no record of a cylinder deactivation. Therefore, the injected fuel concentration needs to be calculated separately for the above-mentioned two types of cylinders. In this case, the routine performs calculations on a cylinder having a record of a cylinder deactivation (a recovered cylinder) in step S310 to determine the current injected fuel concentration En(i), and performs calculations on a cylinder having no record of a cylinder deactivation (a non-deactivated cylinder) in step S314 to determine the current injected fuel concentration En(i).

In step S310, the routine calculates the current injected fuel concentration En(i) in the recovered cylinder from the amount of fuel consumed in the recovered cylinder and the fuel concentration in the delivery pipe 8. More specifically, the routine uses Equation 1 below to calculate the injected fuel concentration En(i). In Equation 1, Qn represents the amount of fuel injected into the n-th cylinder.

En(i)={En(i-1)×(Vinj−Qn(i-1))+Ed(i-1)×Qn(i-1)}/Vinj Equation 1

When the above-described routine is executed, the injected fuel concentration in each cylinder can be accurately estimated. The fuel injection amount control section 30 sets a target air-fuel ratio for each cylinder in accordance with the injected fuel concentration that is accurately estimated as described above, and exercises cylinder-specific fuel injection amount control in accordance with the target air-fuel ratio for each cylinder. Therefore, even if the fuel existing before a concentration change remains in the injector due to a cylinder deactivation, an air-fuel ratio difference between cylinders is avoided when recovery from a cylinder deactivation is achieved. Further, if there should be an air-fuel ratio difference between the cylinders, the difference is extremely small as compared to a case where fuel injection amount control is exercised by applying the same target air-fuel ratio to the cylinders.

### Second Embodiment

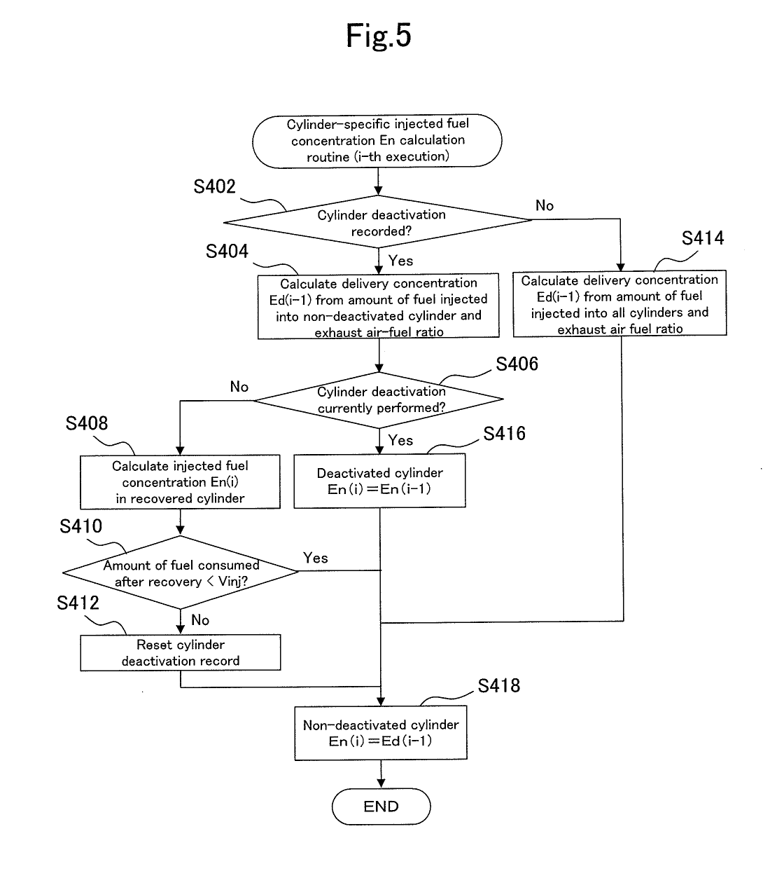

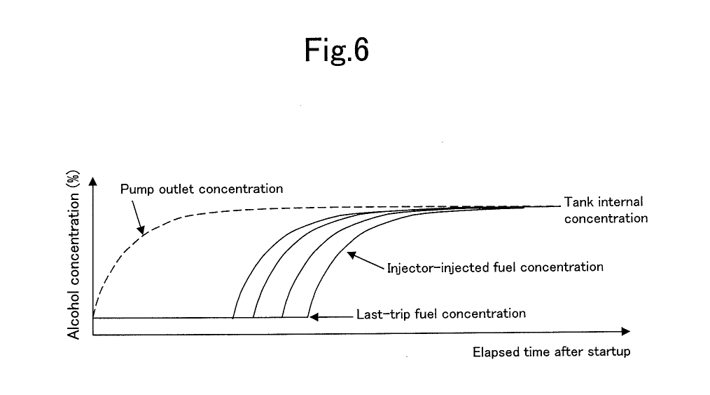

A second embodiment of the present invention will now be described with reference to FIG. 5.

The control device according to the second embodiment is applied to an internal combustion engine having the fuel supply system shown in FIG. 1, as is the case with the control device according to the first embodiment. Therefore, the following description is based on the system shown in FIG. 1, as is the case with the first embodiment.

The second embodiment differs from the first embodiment in the functionality of the fuel injection amount control section 30. More specifically, these two embodiments differ in the method of estimating the injected fuel concentration in each cylinder although are similar to each other in that they control the fuel injection amount on an individual cylinder basis. A routine shown in a flowchart of FIG. 5 is used by the fuel injection amount control section 30 to calculate a cylinder-specific injected fuel concentration. This cylinder-specific injected fuel concentration calculation routine is described below.

Each time the cylinder-specific injected fuel concentration calculation routine shown in FIG. 5 is executed, it calculates an injected fuel concentration in each cylinder. The routine execution count is indicated by “i”, and the injected fuel concentration in the n-th cylinder that is calculated for an i-th time is indicated by En(i).

In step S402, which is the first step, the routine judges whether there is a record of a cylinder deactivation. When there is a record of a cylinder deactivation, the routine proceeds to step S404. When, on the other hand, there is no record of a cylinder deactivation, the routine proceeds to step S414. Steps S404 and S414 are both performed to calculate the fuel concentration in the delivery pipe 8. In the present embodiment, the fuel concentration in the delivery pipe 8 is estimated in accordance with an exhaust air-fuel ratio identified from an air-fuel ratio sensor signal.

When there is a record of a cylinder deactivation, the routine performs step S404 to calculate the last delivery concentration Ed(i-1) from the amount of fuel injected into a non-deactivated cylinder (a cylinder having no record of a cylinder deactivation) and the exhaust air-fuel ratio. When, on the other hand, there is no record of a cylinder deactivation, the routine performs step S414 to calculate the last delivery concentration Ed(i-1) from the amount of fuel injected into all cylinders and the exhaust air fuel ratio. The method of calculating the fuel concentration by using the exhaust air-fuel ratio will not be described in detail because it is publicly known (JP-A-2000-291484).

When the judgment result obtained in step S402 indicates that there is no record of a cylinder deactivation, the routine proceeds to step S318 upon completion of step S414. In step S418, the routine performs calculations on all non-deactivated cylinders to determine the last delivery concentration Ed(i-1) as the current injected fuel concentration En(i).

When, on the other hand, the judgment result obtained in step S402 indicates that there is a record of a cylinder deactivation, the routine proceeds to step S406 upon completion of step S404. In step S406, the routine judges whether a cylinder deactivation is currently performed. When a cylinder deactivation is being performed, the routine performs steps S416 and S418 in sequence. In step S416, the routine performs calculations on a deactivated cylinder to determine the last injected fuel concentration En(i-1) as the current injected fuel concentration En(i). In step S418, the routine performs calculations on a non-deactivated cylinder to determine the last delivery concentration Ed(i-1) as the current injected fuel concentration En(i).

When, on the other hand, no cylinder deactivation is currently performed, the routine proceeds to step S408. In step S408, the routine uses earlier-described Equation 1 to calculate the current injected fuel concentration En(i) in a cylinder having a record of a cylinder deactivation (a recovered cylinder). For the calculation, the last delivery concentration Ed(i-1) calculated in step S404 and the last injected fuel amount Qn(i-1) are used.

In the next step, which is step S410, the routine checks the recovered cylinder to determine whether the amount of fuel consumed after recovery from the cylinder deactivation is smaller than the volumetric capacity of fuel in the injector Vinj. When the amount of fuel consumed after recovery is larger than the volumetric capacity of fuel in the injector Vinj, the fuel existing before a concentration change does not possibly remain in the injector. In this instance, the routine performs step S412 to reset the cylinder deactivation record. The routine then proceeds to the next step, which is step S418, and calculates the current injected fuel concentration En(i) in a non-deactivated cylinder.

When the amount of fuel consumed after recovery is smaller than the volumetric capacity of fuel in the injector Vinj, the fuel existing before a concentration change may remain in the injector. Therefore, the routine proceeds to step S418 without resetting the cylinder deactivation record and calculates the last delivery concentration Ed(i-1) as the current injected fuel concentration En(i).

When the above-described routine is executed, the injected fuel concentration in each cylinder can be accurately estimated, as is the case with the first embodiment. Therefore, even if the fuel existing before a concentration change remains in the injector due to a cylinder deactivation, an air-fuel ratio difference between cylinders is avoided when recovery from a cylinder deactivation is achieved.

### Other

While the present invention has been described in connection with the foregoing embodiments, it should be understood that the present invention is not limited to the foregoing embodiments. The present invention extends to various modifications that nevertheless fall within the scope and spirit of the present invention. For example, the foregoing embodiments may be modified as described below.

In step S102 of the cylinder-to-be-deactivated selection routine shown in FIG. 2, the routine may conclude that the fuel concentration is changed when a predetermined amount of fuel is consumed after a change in the signal of the biofuel concentration sensor 10. This makes it possible to shorten the period during which the deactivation of a particular cylinder is prohibited. Further, in step S104 of the cylinder-to-be-deactivated selection routine, the routine may, instead of estimating the fuel concentration in the delivery pipe 8, conclude that a change in the fuel concentration in the delivery pipe 8 is completed when at least a predetermined amount of fuel is consumed after a change in the signal of the biofuel concentration sensor 10.

FIG. 1 assumes that only the fourth cylinder can be designated as a particular cylinder. However, a plurality of cylinders located farthest from the inlet of the delivery pipe may exist depending on the position at which the fuel line is connected to the delivery pipe. In such an instance, a cylinder that will be affected latest by a fuel concentration change indicated by the result of an experiment may be designated as the particular cylinder. An alternative is to designate each of the plurality of such cylinders as the particular cylinder, and when a cylinder remains deactivated for a certain period, selects another cylinder as the cylinder to be deactivated.

The foregoing embodiments prohibit the deactivation of only a cylinder located farthest from the inlet of the delivery pipe before the completion of a fuel property change in the delivery pipe. Alternatively, however, the deactivation of all cylinders to be deactivated may be prohibited before the completion of a fuel property change in the delivery pipe.

Further, the foregoing embodiments use a biofuel concentration sensor (alcohol concentration sensor) as the fuel property sensor. However, the type of the fuel property sensor to be used may be determined in accordance with an employed fuel. When, for instance, the gasoline used as a fuel for a gasoline engine varies in quality, a sensor for detecting whether the fuel is heavy or light or a sensor for detecting an octane number may be used as the fuel property sensor.

### DESCRIPTION OF REFERENCE NUMERALS

2 Fuel tank
4 Fuel pump
6 Fuel line
8 Delivery pipe
10 Biofuel concentration sensor as fuel property sensor
11, 12, 13, 14 Injector
20 ECU
#1, #2, #3, #4 Cylinder

1. A control device for an internal combustion engine capable of using a plurality of types of fuels having different properties, the control device comprising:
a fuel property sensor that is installed in a fuel line between a fuel tank and a delivery pipe;
fuel property change detection means for detecting a fuel property change from a signal of the fuel property sensor;
cylinder deactivation means for deactivating some of a plurality of cylinders by halting a fuel injection from an injector; and
cylinder deactivation prohibition means for prohibiting the deactivation of a cylinder before the completion of a fuel property change in the delivery pipe when a fuel property change is detected.

2. The control device according to claim 1, wherein the cylinder deactivation prohibition means prohibits the deactivation of a cylinder located farthest from the inlet of the delivery pipe before the completion of a fuel property change in the delivery pipe.

3. The control device according to claim 1, wherein the cylinder deactivation prohibition means prohibits the deactivation of a cylinder affected latest by a fuel property change before the completion of a fuel property change in the delivery pipe.

4. The control device according to claim 1, wherein the cylinder deactivation prohibition means estimates, in accordance with the amount of fuel injected into each cylinder, whether a fuel property change in the delivery pipe is completed.

5. The control device according to claim 1, further comprising:
diagnosis prohibition means for prohibiting the execution of an abnormality diagnosis related to an air-fuel ratio until a predetermined period of time elapses after recovery from a cylinder deactivation.

6. The control device according to claim 1, further comprising:
learning prohibition means for prohibiting the learning of a control parameter related to an air-fuel ratio until a predetermined period of time elapses after recovery from a cylinder deactivation.

7. The control device according to claim 1, further comprising:
delivery pipe internal fuel property estimation means for estimating the property of fuel in the delivery pipe;
injector internal fuel property estimation means for estimating the property of fuel in the injector of a recovered cylinder which has recovered from a cylinder deactivation, in accordance with the amount of fuel consumed in the cylinder and the property of fuel in the delivery pipe; and
fuel injection amount control means for exercising fuel injection amount control of the recovered cylinder in accordance with the estimated fuel property in the injector until a predetermined period of time elapses after the recovery from the cylinder deactivation.

8. The control device according to claim 7, wherein the delivery pipe internal fuel property estimation means estimates the property of fuel in the delivery pipe in accordance with the property of fuel in the fuel line, which is identified from a signal of the fuel property sensor.

9. A control device for an internal combustion engine capable of using a plurality of types of fuels having different properties, the control device comprising:
a fuel property sensor that is installed in a fuel line between a fuel tank and a delivery pipe; and
a controller that is programmed to:
detect a fuel property change from a signal of the fuel property sensor;
deactivate some of a plurality of cylinders by halting a fuel injection from an injector; and
prohibit the deactivation of a cylinder before the completion of a fuel property change in the delivery pipe when a fuel property change is detected.
